(19) United States
(12) Patent Application Publication
(10) Pub. No.: US 2005/0086862 A1
(43) Pub. Date: Apr. 28, 2005

(54) Plant root and bulb protection device

(76) Inventor: Rosemarie P. Denicola, Chester, NJ (US)

Correspondence Address: STEVEN B. STEIN, ESQ.;STEIN & STEIN, 164 ROUTE 10 WEST, SUCCASUNNA, NJ, 07876, US

(21) Appl. No.: 10/694,463

(22) Filed: Oct. 27, 2003

(51) Int. Cl. A01G 9/02; A01G 13/02

(52) U.S. Cl. 47/65.8; 47/24.1

(57) ABSTRACT

The present invention relates to the field of plant root and bulb protection. Specifically, the invention involves a device and method for physically protecting plant root, and planted bulbs from pests, rodents and other vermin. According to one embodiment of the invention, the device comprises a perforated bag of a durable material, resistant to decay. According to an embodiment of this invention, the device is comprised of a perforated, tubular plastic sheath having a perforation pattern optimized to reduce access to pests, rodents and vermin, while enhancing plant root viability.

### FIELD OF THE INVENTION

The present invention relates to the field of plant root and bulb protection. Specifically, the invention involves a device and method for physically protecting plant root, and planted bulbs from pests, rodents and other vermin. According to one embodiment of the invention, the device comprises a perforated bag of a durable material, resistant to decay. According to an embodiment of this invention, the device is comprised of a perforated, tubular plastic sheath having a perforation pattern optimized to reduce access to pests, rodents and vermin, while enhancing plant root viability.

### BACKGROUND OF THE INVENTION

Plant roots and bulbs are vulnerable to destruction by a variety of pests, rodents and vermin. The need to protect plant root systems and bulbs from such destruction has long been recognized. Plant root protection devices have been described (U.S. Pat. No. 6,067,752; U.S. Pat. No. 4,750,292; U.S. Pat. No. 4,706,411; and U.S. Pat. No. 4,357,884). Moreover, devices, which form planting devices in the arrangement of a mesh or grid are known in the prior art as are containment planting devices and perforated planting sleeves (U.S. Pat. No. 5,523,331; U.S. Pat. No. 5,830,119; U.S. Pat. No. 6,058,651). In particular, the prior art describes a mesh-like protection cage, designed to exclude small animals from reaching bulbs or plant roots including an internal flexible liner made from durable material.

The present invention provides distinct advantages over the prior art and solves numerous problems long-described and understood in the field.

### SUMMARY OF THE INVENTION

It is therefore an object of this invention to provide A plant root and bulb guard device comprising a continuous tubular sheet liner, wherein the tubular sheet liner circumscribes an interior side; an exterior side; a closed bottom end; an open top end; and wherein the tubular sheet line comprises a plurality of apertures between the interior side and the exterior side.

### BRIEF DESCRIPTION OF THE FIGURES

FIG. 1. Plant root and bulb protection device comprising continuous tubular sheet liner 1, wherein the tubular sheet liner circumscribes an interior side 2; an exterior side 3; a closed bottom end 4; an open top end 5; and a plurality of apertures 6 between the interior side and the exterior side. The plurality of apertures comprise diagonally-shaped apertures in rows of alternating slit direction 7.

FIG. 2. The plurality of apertures comprise diagonal slits in rows of alternating slit direction 7.

FIG. 3A. Plant root and bulb protection device inserted into the ground 11, showing closure device 8 enclosing the top end 5. FIG. 3B. Plant root and bulb protection device inserted into the ground 11, showing fold-over closure.

### DETAILED DESCRIPTION OF THE INVENTION

The present invention provides a plant root and bulb protection device comprising a continuous tubular sheet liner, wherein the tubular sheet liner circumscribes an interior side; an exterior side; a closed bottom end; an open top end; and wherein the tubular sheet liner comprises a plurality of apertures between the interior side and the exterior side. A plant or bulb may be inserted into the interior of the device together with soil and planted a combination, permitting access of water and nutrients to the interior of the device together with soil and planted a combination, permitting access of water and nutrients to the plant or bulb, while protecting it from pests, rodents and vermin. According to one embodiment of the invention, the liner sheet is biodegradable. According to another embodiment of the invention, the liner sheet is non-biodegradable. According to a preferred embodiment, the tubular sheet liner is comprised of plastic. According to this embodiment, polypropylene, polyethylene, polyurethane, polyvinyl and polycarbonate plastics are preferred. It is preferred that the material be substantially flexible in nature rather than rigid. The material is also preferably resistant to tearing so that it is therefore resistant to invasion by rodents pests and vermin. According to another preferred embodiment of the invention, the apertures are small enough to exclude rodents, pests and vermin. According to one embodiment of the invention, the provided plant and root bulb protection device, further comprising a closure means, capable of enclosing the top end. According to an embodiment of this invention, the closure means is capable of reversible enclosing the top end. Reversibility of the closure device facilitates removal of plants and bulbs for replanting. According to one embodiment of this invention the closure means is a tie. It is contemplated that the tie may be comprised of a number of materials including plastic, cloth and metal. According a preferred embodiment, the tie is a self-tightening plastic tie capable of stably enclosing the top end of the provided device. This preferred embodiment has the advantage of allowing the user to adjust the size of the opening at the top end of the provided device by varying the degree to which the closure means is tightened around the top end. According to another embodiment, the closure means is attached to the device. According to another preferred embodiment the closure means is a pair of interlocking ridges known as a “zip lock” which is integral with the device at its top end, enabling rapid closure. According to another embodiment the closure means may be an adhesive. Alternatively the closure means may be a chemical or thermal seal. According to another embodiment the device may be chemically treated with a deterant compound capable of deterring or repelling pests or rodents. According to a preferred embodiment, such chemical compound is non-toxic. According to another preferred embodiment the chemical compound is environmentally safe.

According to another embodiment the invention further comprises an anchor means, capable of securing the tubular sheet liner to the ground. According to this embodiment, the anchor means may be in the form of a stake, attachable to the provided device and capable of stably anchoring the device to the ground at a particular depth below the ground surface. It is contemplated that the anchor device may be comprised of a number of materials including plastic, wood and metal.

According to another preferred embodiment of the inventions the provided plant and root bulb protection device further comprises a plurality of rows of apertures extending generally from the top end to the bottom end. The apertures effect slit like openings between the interior and the exterior of the device, thereby permitting entry of nutrients and water into the interior of the device from the soil on the exterior. The apertures are of sufficient size to permit transmission of water and nutrients through the aperture. The apertures are sufficiently small in size to substantially preclude transmission of rodents, pests and vermin through the apertures. According to one embodiment of this invention the apertures are diagonally shaped slits. According to a preferred embodiment of this invention, the diagonally shaped slits are arranged as alternating rows of diagonally shaped apertures wherein the diagonal shape is generally oriented from the top end to the bottom end in a left to right direction in a first row and wherein the diagonal shape is generally oriented from the top end to the bottom end in a right to left direction in a second row.

Finally, the present invention provides a method for protecting plant and root bulbs comprising insertion of a plant into the plant and root bulb protection device of claim 1 and insertion of the device into the ground.

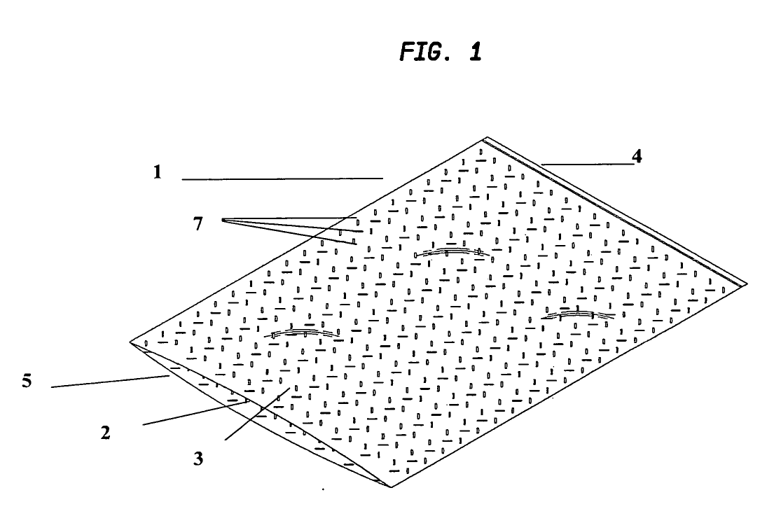

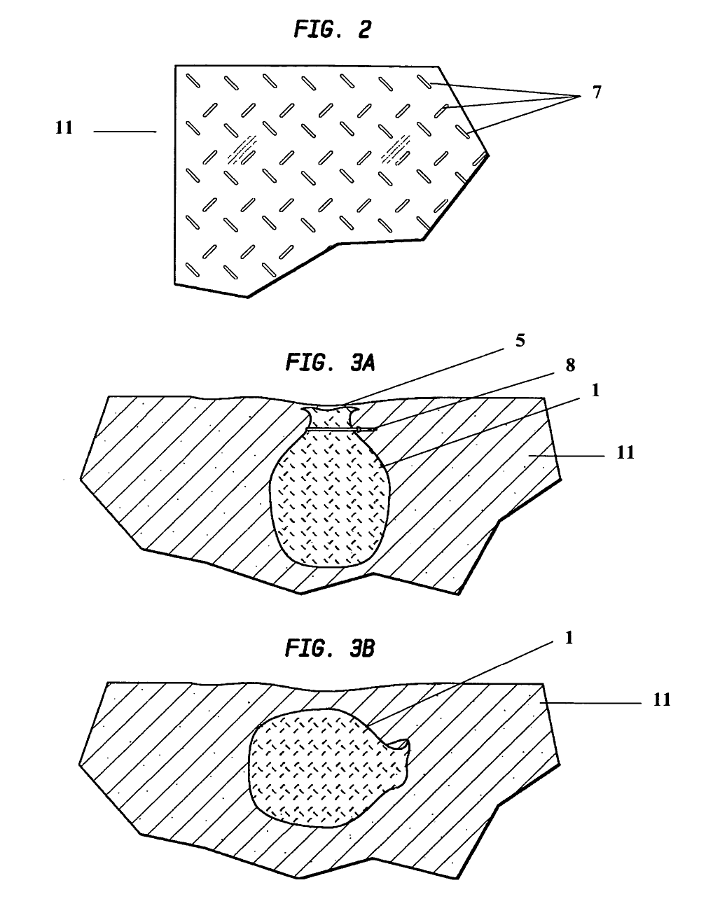

Referring now to the figures: FIG. 1 shows the provided plant root and bulb protection device comprising continuous tubular sheet liner 1, wherein the tubular sheet liner circumscribes an interior side 2; an exterior side 3; a closed bottom end 4; an open top end 5; and a plurality of apertures 6 between the interior side and the exterior side. The plurality of apertures comprises diagonally shaped apertures in rows of alternating slit direction 7. FIG. 2 shows the plurality of apertures comprise diagonal slits in rows of alternating slit direction 7. FIG. 3 shows the provided plant root and bulb protection device inserted into the ground 11, showing closure device 8 enclosing the top end 5.

According to the present invention, the provided device is for in ground use. The device provides the flexibility of being easily removed or remaining in the ground as a permanent barrier protecting against destruction of plant roots and bulbs from burrowing rodent pests and vermine, while enhancing plant root development and bulb viability. The interior provides sufficient space for root system development. A bulb or plant root may be loaded by insertion through the top end opening into the interior of the device together with natural soil or other growth media. The top end opening may then be substantially closed utilizing the described closure means. Alternatively, the loose ends of the top end opening may be gathered or folded over without need for a closure means. The loaded device may then be “planted” in the ground. Following a growth season or for purposes such as bulb division, relocation or replanting, the loaded device may be explanted from the ground and the plant or bulb removed. No special tools or watering attachments are required.

The present invention solves a long standing problem concerning plant root and bulb destruction by pests, rodents and vermin without need for chemical repellents or complex or dangerous devices. The present invention provides a solution that is as easy and simple as present standard planting techniques, while providing superior protection for plant roots and bulbs.

Throughout this application, various publications and patents and patent applications are referenced. The disclosures of these publications in their entireties are hereby incorporated by reference into this application in order to more fully describe the state of the art.

This invention may be embodied in other forms or carried out in other ways without departing from the spirit or essential characteristics thereof. The present disclosure is therefore to be considered as in all respects illustrative and not restrictive, the scope of the invention being indicated by the appended claims, and all changes which come within the meaning and range of equivalency are intended to be embraced therein.

1. A plant root and bulb protection device comprising:
a. a continuous tubular sheet liner, wherein the tubular sheet liner circumscribes
i. an interior side;
ii. an exterior side;
iii. a closed bottom end;
iv. an open top end; and
b. wherein the tubular sheet line comprises a plurality of apertures between the interior side and the exterior side.

2. The plant and root bulb protection device of claim 1, further comprising a closure means, capable of enclosing the top end.

3. The plant and root bulb protection device of claim 1, further comprising an anchor means, capable of securing the tubular sheet liner to the ground.

4. The plant and root bulb protection device of claim 2, wherein the closure means is capable of reversible enclosing the top end.

5. The plant and root bulb protection device of claim 2, wherein the closure means is a tie.

6. The plant and root bulb protection device of claim 1, wherein the device further comprises a plurality rows of apertures extending generally from the top end to the bottom end.

7. The plant and root bulb protection device of claim 1, wherein the plurality of apertures further comprises a plurality of diagonally shaped apertures.

8. The plant and root bulb protection device of claim 1, wherein the plurality of apertures further comprises alternating rows of diagonally shaped apertures wherein the diagonal shape is generally oriented from the top end to the bottom end in a left to right direction in a first row and wherein the diagonal shape is generally oriented from the top end to the bottom end in a right to left direction in a second row.

9. The plant and root bulb protection device of claim 1, wherein the apertures are capable of preventing passage of vermin from the exterior side to the interior side and wherein the aperture is capable of permitting passage of water from the exterior side to the interior side.

10. The plant and root bulb protection device of claim 1, wherein the liner sheet is comprised of plastic.

11. The plant and root bulb protection device of claim 1, wherein the liner sheet is biodegradable.

12. The plant and root bulb protection device of claim 1, wherein the liner sheet is non-biodegradable.

13. A method for protecting plant roots and bulbs comprising insertion of a plant into the plant and root bulb protection device of claim 1 and insertion of the device into the ground.

14. The method for protecting plant roots and bulbs of claim 13, further comprising insertion of soil into the device of claim 1.
